(19) United States
(12) Patent Application Publication
(10) Pub. No.: US 2008/0068282 A1
(43) Pub. Date: Mar. 20, 2008

(54) Antenna apparatus

(75) Inventor: Takeshi Iizuka, Katagami-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Mitsumi Electric Co., Ltd., Tama-shi (JP)

(21) Appl. No.: 11/881,095

(22) Filed: Jul. 25, 2007

(30) Foreign Application Priority Data
Sep. 19, 2006 (JP) 2006-252190

(51) Int. Cl. H01Q 1/50

(52) U.S. Cl. 343/906

(57) ABSTRACT

Disclosed is an antenna apparatus, including: a first circuit substrate and a second circuit substrate, the first and second circuit substrates being disposed side by side independently of each other; an antenna element disposed on the first circuit substrate; and a coaxial connector attached to one of the first and second circuit substrates at a position near the other of the circuit substrates substantially perpendicularly to the one of the circuit substrates, wherein a ground wiring of the first circuit substrate and a ground wiring of the second circuit substrate are connected to each other through a conductive plate forming a bridge over a gap between the first and second circuit substrates, and are connected to an outer conductor, through which ground potential is to be supplied, of the coaxial connector.

### BACKGROUND OF THE INVENTION

1. Field of the Invention

The present invention relates to an antenna apparatus, and more particularly to an antenna apparatus combining a circuit substrate for a satellite radio and a circuit substrate for an AM/FM radio.

2. Description of Related Art

For example, the following antenna apparatus was developed as an in-car or in-home fixed antenna apparatus for a satellite radio, which was put to practical use in the USA, (see, for example, Japanese Patent Application Laid-Open Publications No. 2005-110007, No. 2004-72320, and No. 2004-228357).

In an antenna apparatus 100, as shown in FIGS. 5A and 5B, an antenna element 102 is provided with a patch type receiving surface 101 on a surface on one side thereof and a metal thin film-like GND(ground) pattern 107 on a surface on the other side thereof. A circuit substrate 103 is provided with a metal thin film-like GND pattern 108 formed on a surface on one side thereof. The GND pattern 107 of the antenna element 102 is stuck to the GND pattern 108 of the circuit substrate 103 with an adhesive member 109, such as a double-coated adhesive tape, put between both the GND patterns 107 and 108. The GND pattern 108 of the circuit substrate 103 also functions as the GND pattern of the antenna element 102 together with the GND pattern 107 of the antenna element 102 itself.

A not shown amplifier circuit is formed on the surface on the other side of the circuit substrate 103, i.e., the surface on the lower side in the drawing, and a GND of the amplifier circuit is connected to the GND pattern 108 of the circuit substrate 103 through a not shown plurality of through-holes formed in the circuit substrate 103. Moreover, an input pin 105 is inserted through the antenna element 102 and the circuit substrate 103 at a predetermined position of them perpendicularly to them. One end of the input pin 105 is soldered to the receiving surface 101 of the antenna element 102, and the other end of the input pin 105 is soldered to the amplifier circuit to be used as an input portion 103a of the amplifier circuit. The input pin 105 inputs an electric wave signal received by the receiving surface 101 into the amplifier circuit through the input portion 103a.

As shown in FIGS. 5A, 5B, and 6, a shield cover 104, which is made of a metal and is shaped in substantially a box, is attached onto the surface of the circuit substrate 103 on the side where the amplifier circuit is formed. The shield cover 104 is attached onto the surface to cover the amplifier circuit, and shields the amplifier circuit from disturbing waves from the outside. Moreover, as shown in FIG. 6, the shield cover 104 is soldered to the GND of the amplifier circuit on the circuit substrate 103 to be electrically connected to the GND. Incidentally, FIG. 6 shows the circuit substrate 103, the shield cover 104, and the like, of the antenna apparatus 100 in the state of being turned upside down.

Moreover, a coaxial cable 106 is inserted into the shield cover 104, and the core wire 106a thereof is soldered to the amplifier circuit on the circuit substrate 103 to be used as an output portion 103b of the amplifier circuit. The coaxial cable 106 supplies drive power to the amplifier circuit through the core wire 106a, and outputs to the downstream side a signal that has been received by the antenna element 102 and amplified by the amplifier circuit to be output through the output portion 103b.

A tongue flap 104b formed by bending the base surface 104a of the shield cover 104 is soldered to an outer conductor 106b of the coaxial cable 106 to be electrically connected to outer conductor 106b. The GND potential is supplied to the outer conductor 106b of the coaxial cable 106, and the GND potential is supplied from the outer conductor 106b of the coaxial cable 106 to the amplifier circuit and the GND pattern 108 of the circuit substrate 103 through the tongue flap 104b and the shield cover 104.

Moreover, a bottom cover 110 made of a metal is provided to touch the base surface 104a of the shield cover 104, and the grounding efficiency of the shield cover 104 is further improved by bringing the bottom cover 110 into the surface contact with the shield cover 104.

If the antenna apparatus 100 for a satellite radio like this is used as an in-car or in-home fixed antenna apparatus, it is convenient to be able to receive not only the satellite radios but also AM radios and FM radios concurrently. Accordingly, it is conceivable that the antenna apparatus 100 for a satellite radio and an antenna apparatus for an AM/FM radio are integrated into one antenna apparatus.

Moreover, in the integrated antenna apparatus, for example, if the amplifier circuit for a satellite radio and an amplifier circuit for an AM/FM radio are formed on one circuit substrate as the antenna apparatus described in Japanese Patent Application Laid-Open Publication No. 2005-20465, then the structure of the antenna apparatus is efficient. However, if only one substrate is used, then noise on the AM/FM side flows out to the satellite radio side, and a problem of unwanted radiation is brought out.

### SUMMARY OF THE INVENTION

The present invention was made in view of such a situation, and aims to provide an antenna apparatus including a plurality of antenna units which are disposed side by side, the antenna apparatus being capable of preventing an occurrence of unwanted radiation, which is inflow of noise from one of the antenna units to an amplifier circuit of the other of the antenna units.

According to a first aspect of the present invention, there is provided an antenna apparatus, comprising:

a first circuit substrate and a second circuit substrate, the first and second circuit substrates being disposed side by side independently of each other;

an antenna element disposed on the first circuit substrate; and

a coaxial connector attached to one of the first and second circuit substrates at a position near the other of the circuit substrates substantially perpendicularly to the one of the circuit substrates, wherein

a ground wiring of the first circuit substrate and a ground wiring of the second circuit substrate are connected to each other through a conductive plate forming a bridge over a gap between the first and second circuit substrates, and are connected to an outer conductor, through which ground potential is to be supplied, of the coaxial connector.

According to a second aspect of the present invention, there is provided an antenna apparatus, comprising:

a first circuit substrate and a second circuit substrate, the first and second circuit substrates being disposed side by side independently of each other;

an antenna element disposed on the first circuit substrate; and

a coaxial cable attached to one of the first and second circuit substrates at a position near the other of the circuit substrates substantially perpendicularly to the one of the circuit substrates, wherein

a ground wiring of the first circuit substrate and a ground wiring of the second circuit substrate are connected to each other through a conductive plate forming a bridge over a gap between the first and second circuit substrates, and are connected to an outer conductor, through which ground potential is to be supplied, of the coaxial cable.

### BRIEF DESCRIPTION OF THE DRAWINGS

The present invention will become more fully understood from the detailed description given hereinbelow and the appended drawings which given by way of illustration only, and thus are not intended as a definition of the limits of the present invention, and wherein;

FIG. 1 is a schematic perspective view showing the configuration of an antenna apparatus according to a preferred embodiment of the present invention;

FIG. 2 is a schematic side view of the antenna apparatus of FIG. 1;

FIG. 3 is a schematic top view of a coaxial connector portion of the antenna apparatus according to the present embodiment;

FIG. 4A is a graph showing a relation between frequency and gain in the antenna apparatus according to the present embodiment;

FIG. 4B is a graph showing a relation between frequency and gain in the antenna apparatus shown in FIG. 7;

FIG. 5A is a schematic sectional view showing the configuration of a conventional antenna apparatus for a satellite radio;

FIG. 5B is an enlarged sectional view of a bonding portion of an antenna element and a circuit substrate of the antenna apparatus shown in FIG. 5A;

FIG. 6 is a perspective view showing a shield cover and the like in the state of the antenna apparatus, shown in FIGS. 5A and 5B, turned upside down; and

FIG. 7 is a schematic side view showing an antenna apparatus including an antenna unit for a satellite radio and an antenna unit for an AM/FM radio that are provided side by side.

### DESCRIPTION OF THE PREFERRED EMBODIMENTS

In the following, an embodiment of an antenna apparatus according to the present invention will be described with reference to the attached drawings.

FIG. 7 is a schematic side view showing an antenna apparatus 200 including an antenna unit 300 for a satellite radio and an antenna unit 400 for an AM/FM radio that are provided side by side. A circuit substrate 301 of the antenna unit 300 and a circuit substrate 401 of the antenna unit 400 are provided independently of each other.

In this case, the antenna unit 300 for a satellite radio is configured to be basically the same as the antenna apparatus 100 (shown in FIG. 5A), and includes an antenna element 302, a shield cover 303, not shown respective GND(ground) patterns of the antenna element 302 and the circuit substrate 301, and the like.

On the other hand, in the antenna apparatus 200, the circuit substrate 301 is extended to a side of the circuit substrate 401 for an AM/FM radio, and a coaxial connector 500 is attached to an extended portion of the circuit substrate 301 substantially perpendicularly to a surface of the circuit substrate 301. Moreover, a GND pattern, though it is not shown in FIG. 7, similar to the GND pattern 108 of the circuit substrate 103 shown in FIGS. 5A and 5B is provided to extend to the coaxial connector 500 on the circuit substrate 301, and is connected to terminals 501 of an outer conductor of the coaxial connector 500. Moreover, a terminal 502 of an inner conductor of the coaxial connector 500 is connected to a not shown output portion of an amplifier circuit in the shield cover 303, and the terminal 502 outputs a signal output from the amplifier circuit to the downstream side.

Also, on the AM/FM radio side, a GND of the circuit substrate 401 is similarly connected to an outer conductor of a coaxial connector for an AM/FM radio to be grounded independently of the antenna unit 300, although the configuration is not shown. Moreover, an output signal amplified by an amplifier circuit for an AM/FM radio is output to the downstream side through an inner conductor of the coaxial connector for an AM/FM radio.

However, in the case where the antenna apparatus 200 was configured as described above, it was found that there was caused a problem, in turn, of the insufficiency of GND because a remaining voltage in the amplifier circuit was not discharged to the outer conductor of the coaxial connector 500 owing to the high frequency characteristics of the antenna unit 300 for a satellite radio. If the GND becomes insufficient like this, then operation situation of the amplifier circuit becomes deteriorated, and the total gain of the antenna unit 300 deteriorates as a result.

As mentioned above, in the case where a plurality of antenna units were integrated besides the case of the combination of the antenna unit for a satellite radio and the antenna unit for an AM/FM radio, it was found that the problem of the deterioration of the total gain owing to the insufficient GND of at least one of the antenna units was caused.

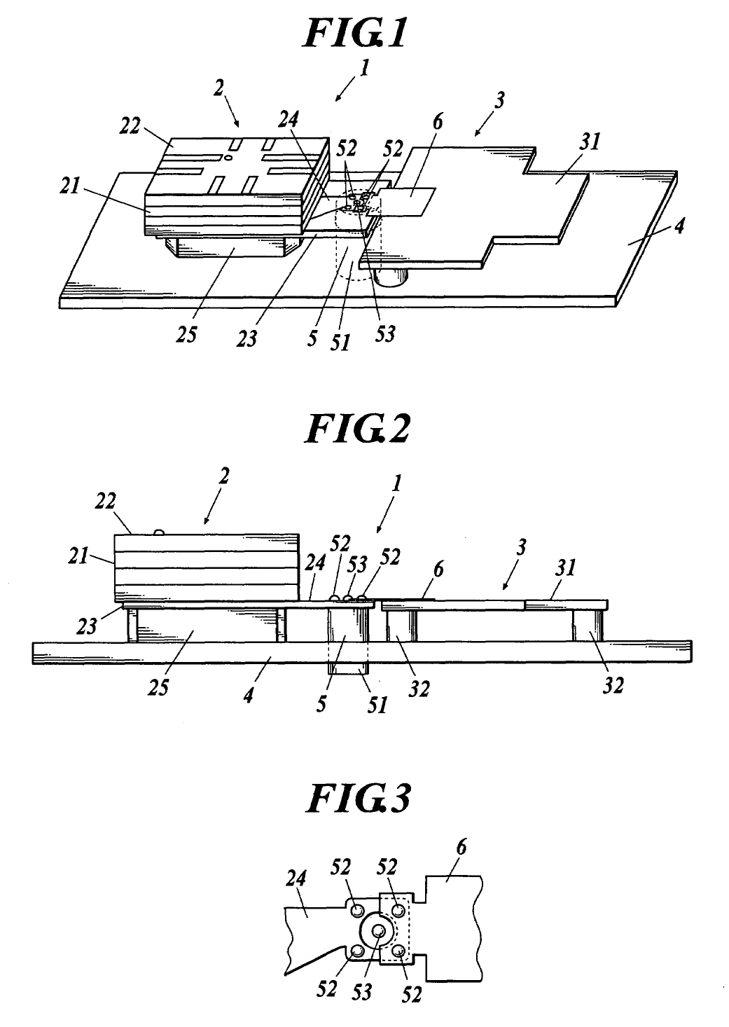

An antenna apparatus 1 according to the present embodiment includes an antenna unit 2 for a satellite radio, an antenna unit 3 for an AM/FM radio, a base member 4, a coaxial connector 5, a plate 6, and the like, as shown in FIGS. 1 and 2. In the present embodiment, a circuit substrate 23 for a satellite radio constitutes a first circuit substrate, and a circuit substrate 31 for an AM/FM radio constitutes a second circuit substrate. The circuit substrates 23 and 31 will be described later.

The antenna unit 2 for a satellite radio of the antenna apparatus 1 has a configuration similar to that of the antenna apparatus 100 shown in FIGS. 5A and 5B. A patch type receiving surface 22 receiving electric waves is formed on a surface on one side of an antenna element 21, and a not shown GND pattern is stuck on almost the whole surface on the opposite side of an antenna element 21 except for the circumjacent portion of a not shown input pin.

Moreover, a GND pattern 24 formed as an independent body of the GND pattern of the antenna element 21 is formed on a surface of the circuit substrate 23 on the side of the antenna element 21 in almost the whole area of the portion opposed to the antenna element 21 except for the circumjacent portion of the input pin. The GND pattern of the antenna element 21 is bonded to the GND pattern 24 of the circuit substrate 23 with an adhesive member, such as a double-coated adhesive tape, and thereby the antenna element 21 is disposed on the circuit substrate 23.

A not shown amplifier circuit is formed on the surface of the circuit substrate 23 on the lower side in the drawings, and a GND of the amplifier circuit is connected to the GND pattern 24 on the back surface side through a not shown plurality of through-holes formed in the circuit substrate 23. By grounding of the GND pattern 24 in this manner, also the GND pattern 24 of the circuit substrate 23 functions as the GND pattern of the antenna element 21 together with the GND pattern of the antenna element 21 itself.

Moreover, a shield cover 25 is attached to the circuit substrate 23 to cover the amplifier circuit of the circuit substrate 23, and the shield cover 25 is connected to the GND of the amplifier circuit. The shield cover 25 is provided to be placed on the base member 4, and is grounded by the surface contact with the base member 4.

The base member 4 constitutes a bottom cover that is a part of a not shown antenna case protecting the antenna apparatus 1 by wrapping around the whole body thereof, and the base member 4 is made of a metal to have a substantially flat surface. Incidentally, the base member 4 is shown as a rectangle in FIG. 1, but may be formed in a suitable shape according to the shape of the antenna case.

In the present embodiment, the circuit substrate 23 is extended to the side of the antenna unit 3 for an AM/FM radio, and the coaxial connector 5 is attached to the circuit substrate 23 in the neighborhood of the end of the circuit substrate 23 substantially perpendicularly to the surface of the circuit substrate 23. The coaxial connector 5 can be firmly attached to the circuit substrate 23, and it can be prevented that the coaxial connector 5 comes out of the circuit substrate 23 even if various kinds of force are applied to the coaxial connector 5 when the antenna apparatus 1 is attached to a car or the like.

Moreover, the aforesaid GND pattern 24 of the circuit substrate 23 is extended on the substrate surface up to the position of the coaxial connector 5, and is connected to terminals 52 of an outer conductor 51 of the coaxial connector 5 as a GND wiring of the circuit substrate 23.

At this time, as shown in the top view of FIG. 3, the GND pattern 24 is soldered to be electrically connected to all of the four terminals 52, which pierce the circuit substrate 23 to project from the surface of the circuit substrate 23, of the outer conductor 51 of the coaxial connector 5 by coupling the four terminals 52 into a ring enclosing a terminal 53 of an inner conductor. Moreover, the terminal 53 of the not shown inner conductor of the coaxial connector 5 is connected to a not shown output portion of the amplifier circuit in the shield cover 25 through not shown wiring.

The antenna unit 3 for an AM/FM radio includes the circuit substrate 31 formed as an independent body of the circuit substrate 23 of the antenna unit 2 for a satellite radio as shown in FIG. 1 and the like. The circuit substrate 23 and the circuit substrate 31 are provided parallel to each other. The circuit substrate 31 is attached to the base member 4 so as to have a height of the surface of the circuit substrate 31 from the base member 4 to be almost the same as that of the circuit substrate 23.of the antenna unit 2 for a satellite radio. The circuit substrate 31 and the circuit substrate 23 are disposed side by side.

A not shown amplifier circuit, which is formed in a predetermined pattern and includes a low pass filter and the like, is formed on a surface of the circuit substrate 31 on the upper side in the drawings, and a not shown antenna portion is connected the amplifier circuit. Moreover, an output portion of the amplifier circuit is connected to an inner conductor of a coaxial connector for an AM/FM radio through pattern wiring, although they are not shown.

Between the circuit substrate 23 of the antenna unit 2 for a satellite radio and the circuit substrate 31 of the antenna unit 3 for an AM/FM radio, a conductive plate 6 is provided in the manner of forming a bridge over the gap between the substrates 23 and 31. In the present embodiment, the plate 6 is made of a metal.

One end side of the plate 6 is soldered to be electrically connected to a not shown GND wiring of the amplifier circuit on the circuit substrate 31 of the antenna unit 3 for an AM/FM radio, and the other end side of the plate 6 is soldered to be electrically connected to the terminals 52 of the outer conductor of the coaxial connector 5 and the GND pattern 24 of the antenna unit 2 for a satellite radio as shown in FIG. 3.

In this manner, the GND wiring of the circuit substrate 31 of the antenna unit 3 for an AM/FM radio and the GND pattern 24, which is the GND wiring of the circuit substrate 23 of the antenna unit 2 for a satellite radio, are connected to each other through the plate 6. Moreover, these GND wirings are connected to the outer conductor 51 of the coaxial connector 5 through the terminals 52.

Moreover, as shown in FIG. 1, the plate 6 as an extension of the GND wiring of the circuit substrate 31 of the antenna unit 3 for an AM/FM radio, and the GND pattern 24 which is the GND wiring of the circuit substrate 23 of the antenna unit 2 for a satellite radio are provided to extend symmetrically to each other with respect to the outer conductor 51 of the coaxial connector 5.

Incidentally, the coaxial connector 5 is shaped to be coupled with a female connector provided in a not shown car or the like. The GND potential is supplied to the outer conductor 51 of the coaxial connector 5, and the GND potential is supplied from the terminals 52 of the outer conductor 51 of the coaxial connector 5 to the respective amplifier circuits of the antenna units 2 and 3 through the GND pattern 24 and the plate 6.

Moreover, the coaxial connector 5 supplies drive power to the amplifier circuit for a satellite radio of the antenna unit 2 through the terminal 53 of the inner conductor, and an amplified signal for a satellite radio amplified by the amplifier circuit of the antenna unit 2 is output through the terminal 53 to be output to the outside of the apparatus through the inner conductor. Moreover, drive power is supplied to the amplifier circuit for an AM/FM radio of the antenna unit 3 through the inner conductor of the not shown coaxial connector for an AM/FM radio, and an amplified signal for an AM/FM radio amplified by the amplifier circuit of the antenna unit 3 is output to be output to the outside of the apparatus through the inner conductor of the coaxial connector.

Furthermore, in the present embodiment, the GND wiring of the amplifier circuit on the circuit substrate 31 of the antenna unit 3 for an AM/FM radio is connected to the terminals 52 of the outer conductor 51 of the coaxial connector 5 and the GND pattern 24 of the antenna unit 2 for a satellite radio through the plate 6, and the GND of the amplifier circuit is connected to the base member 4 through supporting members 32, shown in FIG. 2, of the circuit substrate 31.

Next, the operation of the antenna apparatus 1 according to the present embodiment will be described.

Drive power is supplied to the circuit substrate 23, which is the first circuit substrate, of the antenna unit 2 for a satellite radio of the antenna apparatus 1 through the inner conductor of the coaxial connector 5, and is supplied to the circuit substrate 31, which is the second circuit substrate, of the antenna unit 3 for an AM/FM radio through the inner conductor of the coaxial connector for an AM/FM radio.

The antenna unit 2 for a satellite radio receives a high frequency electric wave for a satellite radio in a frequency band of about 2.3 GHz with the receiving surface 22 of the antenna element 21, and amplifies the received electric wave signal with the amplifier circuit on the circuit substrate 23 to output the amplified electric wave signal from the output portion of the amplifier circuit to the outside of the apparatus through the inner conductor of the coaxial connector 5. Moreover, the antenna unit 3 for an AM/FM radio receives AM and FM electric waves with the antenna portions thereof, respectively, to amplify the received electric wave signals with the amplifier circuit on the circuit substrate 31, and outputs the amplified signals from the output portion of the amplifier circuit to the outside of the apparatus through the inner conductor of the coaxial connector for an AM/FM radio.

Moreover, the GND potential is supplied to the outer conductor 51 of the coaxial connector 5, and the GND potential is supplied to the respective amplifier circuits on the circuit substrates 23 and 31 through the terminals 52.

As described above, each of the circuit substrate 23 for a satellite radio and the circuit substrate 31 for an AM/FM radio are formed as independent bodies of each other to be separated from each other. Moreover, the amplifier circuit for an AM/FM radio eliminates noise from amplified signals with a low pass filter or the like.

Consequently, no high frequency noise flows out from the antenna unit 3 for an AM/FM radio to the antenna unit 2 for a satellite radio, and generation of unwanted radiation is avoided.

On the other hand, no electric potential exists on the GND on the side of the antenna unit 3 for an AM/FM radio at least in the frequency band of about 2.3 GHz for a satellite radio, i.e., the electric potential of the GND wiring in that frequency band is zero volts. Consequently, by the connection of the GND pattern 24, which is the GND wiring of the antenna unit 2 for a satellite radio, with the GND wiring of the antenna unit 3 for an AM/FM radio through the plate 6, the area of the GND of the antenna unit 2 for a satellite radio is secured to be wider by the GND on the circuit substrate 31 for an AM/FM radio in comparison with the area of the configuration shown in FIG. 7.

By the expansion of the area of the GND in this manner, voltage remaining in the amplifier circuit of the antenna unit 2 for a satellite radio owing to the high frequency characteristics in the configuration of FIG. 7 can flow out to the side of the circuit substrate 31 for an AM/FM radio, and the GND potential of the amplifier circuit for a satellite radio falls to zero volts.

Moreover, the more the connected GNDs are symmetrical with respect to the outer conductor 51, the more the outer conductor 51 of the coaxial connector 5 efficiently discharges the remaining voltage. Accordingly, the present embodiment arranges the GND pattern 24 which is the GND wiring of the circuit substrate 23 for a satellite radio, and the plate 6 as an extension of the GND wiring of the circuit substrate 31 for an AM/FM radio, to extend symmetrically to each other with respect to the outer conductor 51 of the coaxial connector 5, and thereby the remaining voltage in the amplifier circuit of the antenna unit 2 for a satellite radio efficiently flows out through the coaxial connector 5.

Furthermore, as in the present embodiment, the four terminals 52 of the outer conductor 51 of the coaxial connector 5 are coupled in a ring by the GND pattern 24 which is the GND wiring for a satellite radio, and GND pattern 24 is electrically connected to all the terminals 52. Consequently, the voltage remaining in the amplifier circuit for a satellite radio flows out through the whole body of the outer conductor 51 of the coaxial connector 5 with all the terminals 52, and the outflow efficiency of the remaining voltage is more improved. The GND potential of the amplifier circuit for a satellite radio thus falls to the zero volts more efficiently.

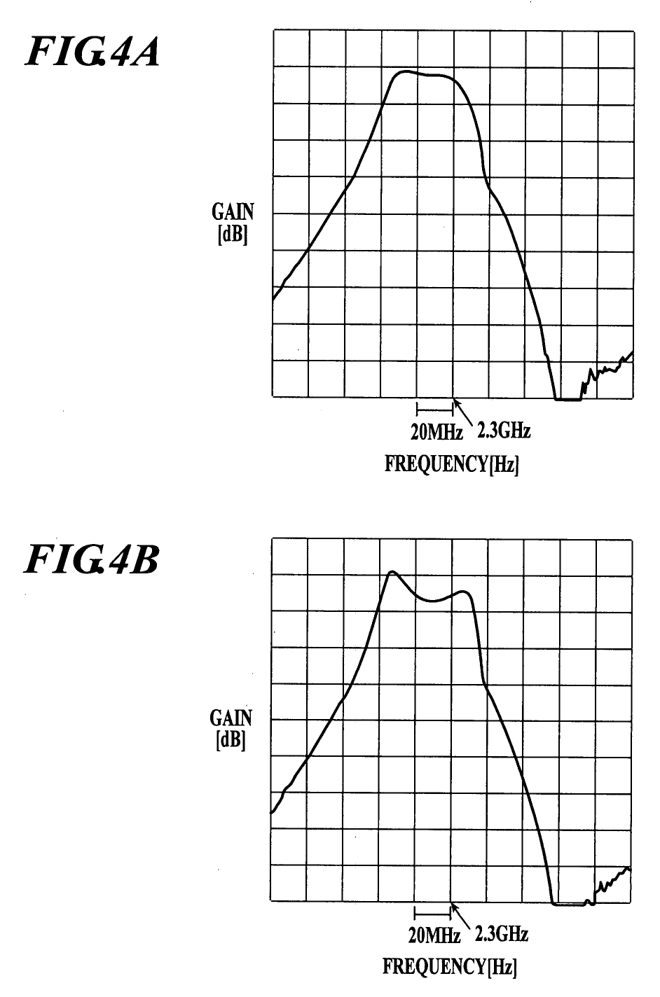

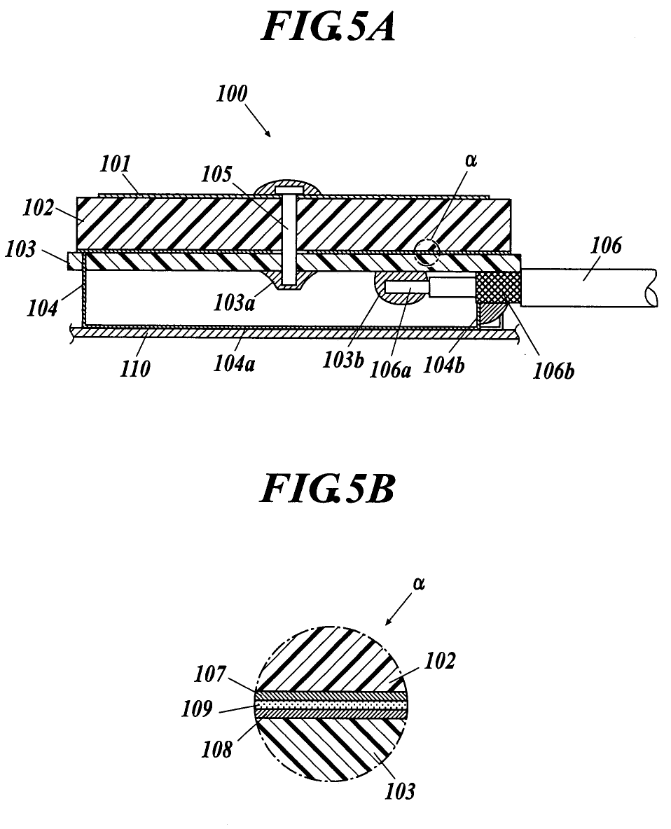

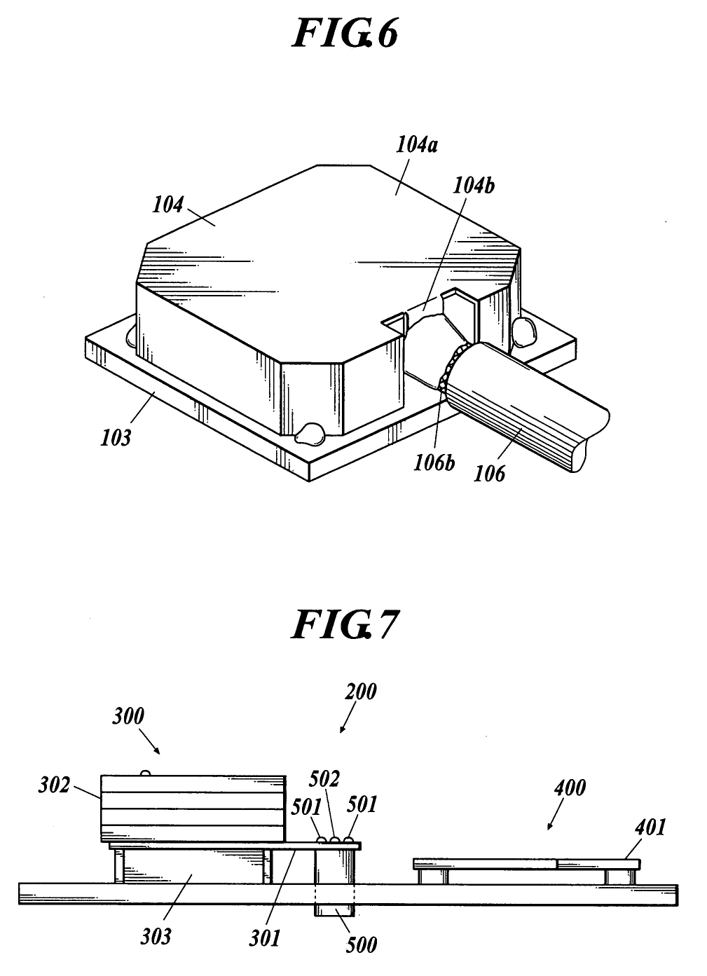

FIG. 4A is a graph showing a relation between frequency and gain of the antenna apparatus 1, which is configured as described above, according to the present embodiment, and FIG. 4B is a graph showing a relation between frequency and gain of the antenna apparatus 200 shown in FIG. 7. Incidentally, in both FIGS. 4A and 4B, the grid interval of the abscissa axes is 20 MHz. Moreover, a well-known measuring method was used for the measuring method of the gains.

As shown in FIG. 4B, in the antenna apparatus 200 shown in FIG. 7, the gain [dB] in the frequency band of about 2.3 GHz for a satellite radio is small, and the gains in a frequency range from about 2.28 GHz to about 2.3 GHz, which this range is practically necessary, lack flatness. On the other hand, in the antenna apparatus 1 shown in FIG. 4A according to the present embodiment, the gain [dB] in the frequency band of about 2.3 GHz for a satellite radio is large, and the flatness of the gains in the frequency range from about 2.28 GHz to about 2.3 GHz, which this range is practically necessary, is kept.

As described above, by the antenna apparatus 1 according to the present embodiment, the circuit substrate 23, which is the first circuit substrate, of the antenna unit 2 for a satellite radio, and the circuit substrate 31, which is the second circuit substrate, of the antenna unit 3 for an AM/FM radio, are disposed side by side independently of each other, and thereby generation of unwanted radiation that is inflow of noise from the circuit substrate 31 for an AM/FM radio to the amplifier circuit for a satellite radio can be surely prevented.

Moreover, the GNDs of the circuit substrates 23 and 31 of the antenna unit 2 for a satellite radio and the antenna unit 3 for an AM/FM radio, respectively, are connected to each other through the plate 6, and thereby the area of the GND of the antenna unit 2 for a satellite radio is secured to be wider by the area of the GND on the circuit substrate 31 for an AM/FM radio. Consequently, the remaining voltage in the amplifier circuit of the antenna unit 2 for a satellite radio can flow out to the side of the circuit substrate 31 for an AM/FM radio, and the GND potential of the amplifier circuit for a satellite radio falls to zero volts.

As a result, the GND of the amplifier circuit for a satellite radio can be sufficiently secured, and the operation situation of the amplifier circuit for a satellite radio is improved to enlarge the total gain of the antenna unit 2 for a satellite radio as shown in FIG. 4A. Moreover, because the gain becomes larger in this manner and also the gain in the high frequency band of about 2.3 GHz, which is practically necessary for a satellite radio, becomes wholly larger, the flatness of the gains in the frequency band can be kept, and the operation situation of the amplifier circuit for a satellite radio is further improved.

At this time, if the GND pattern 24 which is the GND wiring of the circuit substrate 23 for a satellite radio, and the GND wiring of the circuit substrate 31 for an AM/FM radio or the plate 6 as an extension of the GND wiring of the circuit substrate 31, are provided to extend symmetrically to each other with respect to the outer conductor 51 of the coaxial connector 5, then the remaining voltage in the amplifier circuit of the antenna unit 2 for a satellite radio efficiently flows out through the coaxial connector 5 based on the characteristic of the coaxial connector 5 such that the coaxial connector 5 more efficiently discharges the remaining voltage as the connected GNDs are more symmetrical with respect to the outer conductor 51. Consequently, the GND potential of the amplifier circuit for a satellite radio more surely falls to zero volts.

Furthermore, the GND pattern 24 of the circuit substrate 23 for a satellite radio is configured to be electrically connected to all of the plurality of terminals 52, which pierce the circuit substrate 23 to project from the surface of the circuit substrate 23, of the outer conductor 51 of the coaxial connector 5 by coupling them in a ring, and thereby the remaining voltage in the amplifier circuit for a satellite radio flows out through the whole body of the outer conductor 51 of the coaxial connector 5 with all the terminals 52. Consequently, the outflow efficiency of the remaining voltage is more improved, and the GND potential of the amplifier circuit for a satellite radio more efficiently fall to zero volts.

Moreover, if the first circuit substrate is used as the circuit substrate for a satellite radio, then the first circuit substrate has the characteristic such that the discharge of voltage from the amplifier circuit for a satellite radio is difficult owing to the high frequency characteristic of the amplifier circuit, and that the voltage tends to remain. By the adoption of the configuration of the present embodiment, the remaining voltage in the amplifier circuit can flow out to the GND on the side of the circuit substrate for an AM/FM radio, which is the second circuit substrate, and the GND potential of the amplifier circuit for a satellite radio falls to zero volts.

Consequently, even in the amplifier circuit for a satellite radio, the GND level of which is difficult to fall to zero volts, the GND can be sufficiently secured, and the operation situation of the amplifier circuit for a satellite radio is improved to enlarge the total gain of the antenna unit for a satellite radio. If the first circuit substrate is the circuit substrate for a satellite radio, then the advantages of the present embodiment are particularly very effectively exhibited in this manner.

Moreover, by using the second circuit substrate as the circuit substrate for an AM/FM radio like the present embodiment, it becomes possible to build an antenna apparatus that effectively exhibits the advantages of the present embodiment by combining the circuit substrate for an AM/FM radio, which is highly demanded, with a circuit substrate for the other radios.

However, the first circuit substrate and the second circuit substrate of the present invention are not limited to the case where the first and second circuit substrates are the circuit substrate for a satellite radio and the circuit substrate for an AM/FM radio, respectively, like the present embodiment, but the circuit substrates of the present invention can be applied to the combinations of various antennas.

Moreover, it is also possible to use the second circuit substrate only for expanding the GND of the circuit substrate for a satellite radio or the like, which is the first circuit substrate, by configuring the second circuit substrate as a circuit substrate only for a GND pattern without mounting the circuit parts for radios on the second circuit substrate, and the configuration like this is also included in the scope of the present invention.

Incidentally, although the description has been given to the case where the coaxial connector 5 is attached to the end of the circuit substrate 23 for a satellite radio in the present embodiment, it is also possible to attach a coaxial cable to the circuit substrate 23 in place of the coaxial connector 5, and to connect an outer conductor of the coaxial cable to the respective pieces of GND wiring for a satellite radio and for an AM/FM radio. Similar advantages to those of the present embodiment can be thereby obtained.

Furthermore, electrical connection between the base member 4 and the outer conductor 51 of the coaxial connector 5 is suitably performed as the need arises.

According to a first aspect of the preferred embodiments of the invention, there is provided a first antenna apparatus, comprising: a first circuit substrate and a second circuit substrate, the first and second circuit substrates being disposed side by side independently of each other; an antenna element disposed on the first circuit substrate; and a coaxial connector attached to one of the first and second circuit substrates at a position near the other of the circuit substrates substantially perpendicularly to the one of the circuit substrates, wherein a ground wiring of the first circuit substrate and a ground wiring of the second circuit substrate are connected to each other through a conductive plate forming a bridge over a gap between the first and second circuit substrates, and are connected to an outer conductor, through which ground potential is to be supplied, of the coaxial connector.

In the first antenna apparatus, the first circuit substrate and the second circuit substrate are disposed side by side independently of each other, and consequently generation of unwanted radiation, which is inflow of noise from the second circuit substrate to the amplifier circuit of the first circuit substrate, can be surely prevented.

Moreover, by the connection between the GNDs of the first circuit substrate and the second circuit substrate with each other through the plate, the area of the GND of the amplifier circuit of the first circuit substrate is secured to be wider by the GND on the second circuit substrate. Consequently, voltage remaining in the amplifier circuit of the first circuit substrate can flow out to the GND on the side of the second circuit substrate, and the GND potential of the amplifier circuit of the first circuit substrate falls to zero volts.

As a result, the GND of the amplifier circuit of the first circuit substrate can be sufficiently secured, and the operation situation of the amplifier circuit of the first circuit substrate is improved to enlarge the total gain of the antenna unit equipped with the first circuit substrate.

Preferably, there is provided a second antenna apparatus, wherein the ground wiring of the first circuit substrate and the ground wiring of the second circuit substrate are provided to extend symmetrically to each other with respect to the outer conductor of the coaxial connector.

In the second antenna apparatus, the GND wiring of the first circuit substrate and the GND wiring of the second circuit substrate are provided to extend symmetrically to each other with respect to the outer conductor of the coaxial connector, and thereby the remaining voltage in the amplifier circuit of the first circuit substrate efficiently flows out through the coaxial connector based on the characteristic of the coaxial connector such that the coaxial connector more efficiently discharges the remaining voltage as the connected GNDs are more symmetrical with respect to the outer conductor. Consequently, the GND potential of the amplifier circuit of the first circuit substrate can more surely fall to zero volts, and the advantages of the first antenna apparatus can be exhibited more effectively.

Preferably, there is provided a third antenna apparatus, wherein the first circuit substrate extends to a side of the second circuit substrate; the coaxial connector is attached to an extended portion of the first circuit substrate; and the ground wiring of the first circuit substrate is directly connected to the outer conductor of the coaxial connector, and the ground wiring of the second circuit substrate is connected to the outer conductor of the coaxial connector through the conductive plate.

In the third antenna apparatus, the first circuit substrate is extended to the side of the second circuit substrate, and the coaxial connector is attached to the extended portion. Then, the GND wiring of the first circuit substrate is directly connected to the outer conductor of the coaxial connector, and the GND wiring of the second circuit substrate is connected to the outer conductor of the coaxial connector through the plate. Thereby, the antenna apparatus exhibiting the advantages of the aforesaid respective antenna apparatuses can be easily manufactured.

Preferably, there is provided a fourth antenna apparatus, wherein the ground wiring of the first circuit substrate couples a plurality of terminals of the outer conductor of the coaxial connector in a ring to be electrically connected to all the terminals piercing the first circuit substrate to project from a surface of the first circuit substrate.

In the fourth antenna apparatus, the GND wiring of the first circuit substrate is configured to be electrically connected to all of the plurality of terminals, which pierce the first circuit substrate to project from the surface of the first circuit substrate, of the outer conductor of the coaxial connector by coupling them in a ring in the third antenna apparatus, and thereby the remaining voltage in the amplifier circuit of the first circuit substrate flows out through the whole body of the outer conductor of the coaxial connector with all the terminals of the outer conductor of the coaxial connector. Consequently, the outflow efficiency of the remaining voltage is more improved, and the GND potential of the amplifier circuit of the first circuit substrate can more efficiently fall to zero volts, and the advantages of the aforesaid respective antenna apparatuses can be exhibited more effectively.

Preferably, there is provided a fifth antenna apparatus, wherein the first circuit substrate is a circuit substrate for a satellite radio.

In the fifth antenna apparatus, if the first circuit substrate is used as the circuit substrate for a satellite radio, then the first circuit substrate has the characteristic such that the discharge of voltage from the amplifier circuit for a satellite radio is difficult owing to the high frequency characteristic of the amplifier circuit, and that the voltage tends to remain. By adopting the configurations of each of the antenna apparatuses mentioned above, the remaining voltage in the amplifier circuit can flow out to the GND on the side of the second circuit substrate, and the GND potential of the amplifier circuit for a satellite radio falls to zero volts.

Consequently, by adopting the configurations of each of the antenna apparatuses mentioned above, the GND of the amplifier circuit for a satellite radio, the GND level of which is difficult to fall to zero volts, can be sufficiently secured, and the operation situation of the amplifier circuit for a satellite radio is improved to enlarge the total gain of the antenna unit for a satellite radio. If the first circuit substrate is the circuit substrate for a satellite radio, then the advantages of the aforesaid respective antenna apparatuses are particularly very effectively exhibited in this manner.

Preferably, there is provided a sixth antenna apparatus, wherein the second circuit substrate is a circuit substrate for an AM/FM radio.

In the sixth antenna apparatus, by using the second circuit substrate as the circuit substrate for an AM/FM radio, the advantages of the aforesaid respective antenna apparatuses can be precisely exhibited, and it becomes possible to build an antenna apparatus that effectively exhibits the advantages of the aforesaid respective antenna apparatuses by combining the circuit substrate for an AM/FM radio, which is highly demanded, with a circuit substrate for the other radios.

According to a second aspect of the preferred embodiments of the invention, there is provided an antenna apparatus, comprising: a first circuit substrate and a second circuit substrate, the first and second circuit substrates being disposed side by side independently of each other; an antenna element disposed on the first circuit substrate; and a coaxial cable attached to one of the first and second circuit substrates at a position near the other of the circuit substrates substantially perpendicularly to the one of the circuit substrates, wherein a ground wiring of the first circuit substrate and a ground wiring of the second circuit substrate are connected to each other through a conductive plate forming a bridge over a gap between the first and second circuit substrates, and are connected to an outer conductor, through which ground potential is to be supplied, of the coaxial cable.

In the second aspect of the antenna apparatus, the antenna apparatus can be equipped with the coaxial cable in place of the coaxial connector, and a similar advantage to that of the aforesaid first aspect of the antenna apparatus can also be obtained.

The entire disclosure of Japanese Patent Application No. 2006-252190 filed on Sep. 19, 2006, including description, claims, drawings and summary are incorporated herein by reference in its entirety.

Although various exemplary embodiments have been shown and described, the invention is not limited to the embodiments. Therefore, the scope of the invention is intended to be limited solely by the following claims.

What is claimed is:

1. An antenna apparatus, comprising:
a first circuit substrate and a second circuit substrate, the first and second circuit substrates being disposed side by side independently of each other;
an antenna element disposed on the first circuit substrate; and
a coaxial connector attached to one of the first and second circuit substrates at a position near the other of the circuit substrates substantially perpendicularly to the one of the circuit substrates, wherein
a ground wiring of the first circuit substrate and a ground wiring of the second circuit substrate are connected to each other through a conductive plate forming a bridge over a gap between the first and second circuit substrates, and are connected to an outer conductor, through which ground potential is to be supplied of the coaxial connector.

2. The antenna apparatus according to claim 1, wherein the ground wiring of the first circuit substrate and the ground wiring of the second circuit substrate are provided to extend symmetrically to each other with respect to the outer conductor of the coaxial connector.

3. The antenna apparatus according to claim 1, wherein
the first circuit substrate extends to a side of the second circuit substrate;
the coaxial connector is attached to an extended portion of the first circuit substrate; and
the ground wiring of the first circuit substrate is directly connected to the outer conductor of the coaxial connector, and the ground wiring of the second circuit substrate is connected to the outer conductor of the coaxial connector through the conductive plate.

4. The antenna apparatus according to claim 3, wherein
the ground wiring of the first circuit substrate couples a plurality of terminals of the outer conductor of the coaxial connector in a ring to be electrically connected to all the terminals piercing the first circuit substrate to project from a surface of the first circuit substrate.

5. An antenna apparatus, comprising:
a first circuit substrate and a second circuit substrate, the first and second circuit substrates being disposed side by side independently of each other;
an antenna element disposed on the first circuit substrate; and
a coaxial cable attached to one of the first and second circuit substrates at a position near the other of the circuit substrates substantially perpendicularly to the one of the circuit substrates, wherein
a ground wiring of the first circuit substrate and a ground wiring of the second circuit substrate are connected to each other through a conductive plate forming a bridge over a gap between the first and second circuit substrates, and are connected to an outer conductor, through which ground potential is to be supplied, of the coaxial cable.

6. The antenna apparatus according to claim 1, wherein the first circuit substrate is a circuit substrate for a satellite radio.

7. The antenna apparatus according to claim 1, wherein the second circuit substrate is a circuit substrate for an AM/FM radio.
